(19) United States
(12) Patent Application Publication
(10) Pub. No.: US 2022/0332945 A1
(43) Pub. Date: Oct. 20, 2022

(54) PU COMPOSITE RESINS

(71) Applicant: BASF SE, Ludwigshafen am Rhein (DE)

(72) Inventors: Andre MEYER, Lemfoerde (DE); Andreas EMGE, Lemfoerde (DE); Laura FEDDRICH, Lemfoerde (DE)

(21) Appl. No.: 17/641,895

(22) PCT Filed: Sep. 11, 2020
(86) PCT No.: PCT/EP2020/075447

§ 371 Date: Mar. 10, 2022

(30) Foreign Application Priority Data
Sep. 12, 2019 (EP) 19197006.0

(51) Int. Cl. C08L 75/04; C08L 71/08

(52) U.S. Cl. CPC C08L 75/04; C08L 71/08; C08L 2205/16

(57) ABSTRACT

Disclosed herein is a fiber composite material including: (a) a polyurethane obtained reaction of at least the components: (i) a polyisocyanate composition; and (ii) a polyol composition including at least 15% by weight of an at least trifunctional alcohol (ii.1), which exhibits at least two primary hydroxyl groups (ii.1); and (b) fibers which are at least partially embedded in the compact polyurethane.

Further disclosed herein are a process for producing a fiber composite material, a fiber composite material obtained by this process, and a method of using the fiber composite material for producing a pipe, in particular a conical pipe, a pipe connector, a pressure vessel, a storage tank, an insulator, a mast, a bar, a roller, a torsion shaft, a profile, a piece of sports equipment, a molded part, a cover, an automotive exterior part, a rope, a cable, an isogrid structure or a semi-finished textile product.

The invention relates to a fiber composite material comprising the components (a) a polyurethane obtained or obtainable by reaction of at least the components: (i) a polyisocyanate composition; (ii) a polyol composition comprising at least 15% by weight of an at least trifunctional alcohol (ii.1) exhibiting at least two primary hydroxyl groups; and (b) fibers which are at least partially embedded in the compact polyurethane.

The invention further relates to a process for the production of a fiber composite material, to a fiber composite material obtained or obtainable by this process and to the use of the fiber composite material for the production of a pipe, in particular a conical pipe, a pipe connector, a pressure vessel, a storage tank, an insulator, a mast, a bar, a roller, a torsion shaft, a profile, a piece of sports equipment, a molded part, a cover, an automotive exterior part, a rope, a cable, an isogrid structure or a semi-finished textile product.

Filament winding is a manufacturing process for the production of rotationally symmetrical components. In filament winding, the fibers are usually drawn off as a roving from one or more spools, soaked in resin and wound onto a rotating core. A roving is a bundle, strand or multifilament yarn made of parallel filaments (continuous fibers), which is mainly used in the production of fiber composite plastics or fiber-reinforced plastics, a subgroup of composite materials. In principle, in addition to rovings, two-dimensional textiles, such as nonwovens, woven fabrics or knitted fabrics, can also be used. After being wound onto the rotating core, the laminate is cured in an oven. By varying the fiber type, winding angle and layer thickness, laminates with a wide range can be produced, which are used in a wide variety of areas.

Standard requirements for formulations for filament winding are, in particular, long open times of more than 30 minutes, preferably of more than 45 minutes. The reaction mixture must not gel in the open bath in which continuous fibers are impregnated with the respective resin. Furthermore, it is essential that no bubbles form on the surface due to air inclusions during the winding process and, in particular, due to the reaction of atmospheric moisture/moist fibers and isocyanate. It follows from this that conventional polyurethane (PU) formulations for such resin baths use less reactive polyols or catalysts, typically polyols capped with propylene oxide, i.e. with secondary alcohols. Because of the reactivity and because of the hydrophilicity, propylene oxide (PO) is clearly preferred to ethylene oxide (EO).

WO 2016/183073 A1 discloses a process for the production of a composite element by means of fiber winding, wherein amine-initiated polyols are used, the exact composition of which is not disclosed. WO 03/085022 A1 describes a reaction system for use in filament winding, in which an organic polyfunctional resin is used which exhibits hydrogen-comprising reactive groups; the polyols used are almost entirely PO-based.

The use of ethylene oxide-capped polyols is usually avoided, as this would lead to polyol components with short open times and such reactive resins would not be processable with conventional process technology, since the reaction resin would gel after a short time in the open impregnation bath. Shorter curing times, though, are desirable from an economic point of view, and one aim is also to minimize sensitivity to moisture.

An object of the invention was the preparation of PU fiber composites, in the production of which shorter open times are possible and the resin components of which exhibit a low sensitivity to moisture, and also to make possible shorter curing times.

This object was achieved with a fiber composite material comprising the following components:

a) a polyurethane obtained or obtainable by reaction of at least the components:
i) a polyisocyanate composition;
ii) a polyol composition comprising at least 15% by weight, preferably at least 20% by weight, more preferably at least 25% by weight, more preferably at least 30% by weight, of an at least trifunctional alcohol (ii.1), which exhibits at least two primary hydroxyl groups, preferably three primary hydroxyl groups;

b) fibers which are at least partially embedded in the compact polyurethane.

Surprisingly, it was found that the use of at least 15% by weight of an at least trifunctional alcohol (ii.1), which exhibits at least two primary hydroxyl groups, preferably three primary hydroxyl groups, i.e. polyols which exhibit reactive primary hydroxyl groups, during thread winding (in the winding test) led to significantly better results with regard to avoiding unwanted bubble formation. Thus, polyurethanes based on at least 15% by weight of at least trifunctional alcohol (ii.1), which exhibits at least two primary hydroxyl groups, preferably three primary hydroxyl groups, showed no or at most very little bubble formation during thread winding despite high atmospheric humidity of 85%, whereas the use of less than 15% by weight of at least trifunctional alcohol (ii.1), which exhibits at least two primary hydroxyl groups, preferably three primary hydroxyl groups, led to foaming, i.e. undesirable bubbles formed on the component surface. For almost all of the mechanical properties considered, advantages were found when using an at least trifunctional alcohol (ii.1), which exhibits at least two primary hydroxyl groups, preferably three primary hydroxyl groups, in particular with regard to impact strength.

The at least trifunctional alcohol (ii.1), which exhibits at least two primary hydroxyl groups, preferably three primary hydroxyl groups, is preferably selected from the group consisting of trimethylolpropane (TMP), butane-1,2-4-triol, pentane-1,3,5-triol, 3-(hydroxymethyl)pentane-1,2,5-triol, heptane-1,4,7-triol, reaction products of phenol derivatives with at least 2 equivalents of formaldehyde, glycerol, pentaerythritol, sorbitol, mannitol, erythrol, erythrulose, ribulol, ribulose, xylulol, xylulose, fructose, sorbose, tagatose, psicose and ethoxylated polyether polyol; more preferably from the group consisting of trimethylolpropane (TMP), butane-1,2-4-triol, pentane-1,3,5-triol, 3-(hydroxymethyl)pentane-1,2,5-triol, heptane-1,4,7-triol, reaction products of phenol derivatives with at least 2 equivalents of formaldehyde and ethoxylated polyether polyol; more preferably from the group consisting of trimethylolpropane (TMP), butane-1,2-4-triol, pentane-1,3,5-triol, 3-(hydroxymethyl)pentane-1,2,5-triol, heptane-1,4,7-triol and ethoxylated polyether polyol.

According to the invention, a polyisocyanate composition is used according to (i). Use may be made, as di- or polyisocyanates (i), of all aliphatic, cycloaliphatic or aromatic isocyanates known for the production of polyurethanes, and also any mixtures thereof. The polyisocyanate composition here comprises at least one polyisocyanate. According to the invention, the polyisocyanate composition can also comprise two or more polyisocyanates. The at least one polyisocyanate is preferably at least one diisocyanate, more preferably selected from the group consisting of aliphatic, cycloaliphatic, araliphatic and aromatic diisocyanates and mixtures of two or more of these diisocyanates. Mention may specifically be made, for example, of the following aromatic diisocyanates: toluene-2,4-diisocyanate, mixtures of toluene-2,4- and -2,6-diisocyanate, diphenylmethane-4,4′-, -2,4′- and/or -2,2′-diisocyanate (MDI), mixtures of diphenylmethane-2,4′- and -4,4′-diisocyanate, liquid urethane-, carbodiimide- or uretonimine-modified diphenylmethane-4,4′- and/or -2,4-diisocyanate, 4,4′-diisocyanatodiphenylethane, the mixtures of monomeric methanediphenyl diisocyanates and homologs of methanediphenyl diisocyanate having a larger number of rings (polymeric MDI), naphthylene-(1,2)- and -1,5-diisocyanate or prepolymers of these isocyanates and polyols or isocyanates and isocyanate-reactive components. Normal aliphatic and/or cycloaliphatic diisocyanates are used as aliphatic diisocyanates, for example tri-, tetra-, penta-, hexa-, hepta- and/or octamethylene diisocyanate, 2-methylpentamethylene-1,5-diisocyanate, 2-ethylbutylene-1,4-diisocyanate,1-isocyanato-3,3,5-trimethyl-5-(isocyanatomethyl)cyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate, 4,4′-, 2,4′- and/or 2,2′-dicyclohexylmethane diisocyanate or oligomers or prepolymers of these isocyanates. Isocyanate compositions comprising MDI are preferred.

Use is preferably made, as di- or polyisocyanates (i), of isocyanates based on diphenylmethane diisocyanate, for example 2,4′-MDI, 4,4′-MDI or mixtures of these components, optionally also with MDI homologs having a larger number of rings. The di- and polyisocyanates (a) preferably exhibit a functionality of 2.0 to 2.9, particularly preferably 2.0 to 2.8.

Di- and polyisocyanates of the polyisocyanate composition (i) can also be used in the form of polyisocyanate prepolymers. These polyisocyanate prepolymers are obtainable by reacting polyisocyanates (i) described above in excess, for example at temperatures of 30 to 100° C., preferably at approximately 80° C., with compounds with at least two groups which react with isocyanates, to give the prepolymer. The NCO content of polyisocyanate prepolymers according to the invention is preferably from 15% to 33% by weight of NCO, particularly preferably from 25% to 30% by weight of NCO. The viscosity of the di- or polyisocyanates or polyisocyanate prepolymers (i) at 25° C. according to DIN 53019-1 to 3 is preferably between 5 and 1000 mPa·s, more preferably between 5 and 700 mPa·s and particularly preferably between 10 and 400 mPa·s. The di- and/or polyisocyanates (i) particularly preferably exhibit at least 50 mol %, more preferably at least 70 mol %, of isocyanates with a functionality of 2.

In one embodiment, the fiber composite material comprises the following components:

a) a polyurethane obtained or obtainable by reaction of at least the components:
i) a polyisocyanate composition;
ii) a polyol composition comprising at least 15% by weight, preferably at least 20% by weight, more preferably at least 25% by weight, more preferably at least 30% by weight, of an ethoxylated polyether polyol (ii.1);

b) fibers which are at least partially embedded in the compact polyurethane.

In one embodiment of the fiber composite material, the ethoxylated polyether polyol (ii.1) is obtained or obtainable by reaction of:

ii.1.1) a polyol initiator with a functionality of 3 to 6, preferably 3 or 4,

with

ii.1.2) ethylene oxide,

in the presence of an alkoxylation catalyst (ii.1.3);

ii.1.4) optionally further auxiliaries and/or additives.

In one embodiment of the fiber composite material, the ethoxylated polyether polyol (ii.1) exhibits an equivalent molecular weight of less than 200 g/mol, preferably in the range from 50 to 140 g/mol, more preferably in the range from 55 to 135 g/mol, more preferably in the range from 60 to 130 g/mol.

A “polyol with a functionality of 3 to 6” is understood to mean a polyol which on average exhibits in the range from 2.8 to 3.0, or in the range from 3.8 to 4.0, or in the range from 4.8 to 5.0, or in the range from 5.8 to 6.0, hydroxyl groups per molecule. Likewise, a “polyol with a functionality of 3 or 4” is understood to mean a polyol which on average exhibits in the range from 2.8 to 3.0, or in the range from 3.8 to 4.0, hydroxyl groups per molecule. In practice, there is a deviation from the nominal functionality since various side reactions during the polyol synthesis can lead to a functionality which can actually be lower than nominally assumed (M. Ionescu, Chemistry and Technology of Polyols, Rapra, 2005, pp 67-75). In the equivalent molecular weight range of less than 200 g/mol, it is assumed that the functionality is very close to 3 or 4 or 5 or 6, preferably very close to 3 or 4. The equivalent molecular weight (EMW) is defined as the ratio of molecular weight of the polyether polyol (M(polyether polyol)) to functionality (F) of the polyether polyol:

EMW=M(polyether polyol)/F[g]

Alkoxylation catalysts (ii.1.3) are known to a person skilled in the art. Use is made of basic catalysts, such as alkali metal salts, for example sodium methoxide, sodium hydroxide, potassium hydroxide and/or cesium hydroxide, amines, such as, for example, imidazole derivatives, or Lewis acid catalysts, for example boron-based fluorine-containing Lewis acid catalysts, such as BF, or trispentafluorophenylborane.

In one embodiment of the fiber composite material, the ethoxylated polyether polyol (ii.1) exhibits a hydroxyl number of more than 300 mg KOH/g, preferably of more than 450 mg KOH/g, more preferably a hydroxyl number in the range from 300 to 1400 mg KOH/g, more preferably in the range from 450 to 1300 mg KOH/g, more preferably in the range from 450 to 1260 mg KOH/g.

In one embodiment of the fiber composite material, the ethoxylated polyether polyol (ii.1) is used in 15% to 100% by weight, preferably in 20% to 100% by weight, more preferably in 25% to 75% by weight, more preferably in 30% to 50% by weight, based on a total weight of the polyol composition (ii) of 100% by weight.

In one embodiment of the fiber composite material, the ethoxylated polyether polyol (ii.1) exhibits no end groups based on propylene oxide and/or end groups based on butylene oxide; the ethoxylated polyether polyol (ii.1) preferably exhibits exclusively end groups based on ethylene oxide. In one embodiment of the fiber composite material, the ethoxylated polyether polyol (ii.1) exhibits exclusively groups based on ethylene oxide and comprises no groups based on propylene oxide and/or groups based on butylene oxide.

In one embodiment of the fiber composite material, the polyol initiator (ii.1.1) of the ethoxylated polyether polyol (ii.1) comprises a triol with a functionality of 3, preferably a triol of the formula (I):

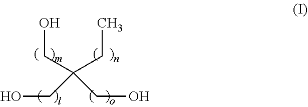

where l, m, n and o are each independently of one another an integer from the range from 1 to 6. Preferably, l, m, n and o of the at least one triol (ii.1.1) of the formula (I) are each independently of one another an integer from the range from 1 to 3; more preferably, l, m, n and o are all 1.

The triol (ii.1.1) preferably exhibits a hydroxyl number in the range from 200 to 2000 mg KOH/g, preferably in the range from 250 to 1850 mg KOH/g, more preferably in the range from 300 to 1850 mg KOH/g.

In one embodiment of the fiber composite material, the ethoxylated polyether polyol (ii.1) is produced only by the reaction of a polyol initiator (ii.1.1.), in particular of a triol of the formula (I), and ethylene oxide (ii.1.2), and no further alkylene oxide is used.

In one embodiment of the fiber composite material, the ethoxylated polyether polyol (ii.1) produced by the reaction of a polyol initiator (ii.1.1.), in particular of a triol of the formula (I), and ethylene oxide (ii.1.2) is used in combination with one or more triol(s) with at least 2 primary hydroxyl groups. Use is made, as the triol(s) employed in this connection, of the at least trifunctional alcohols (ii.1) described above, which exhibit at least two primary hydroxyl groups, preferably three primary hydroxyl groups, with the exception of the ethoxylated polyether polyol.

In one embodiment of the fiber composite material, the ethoxylated polyether polyol (ii.1) is produced only by the reaction of a polyol initiator (ii.1.1.), in particular triol of the formula (I), and ethylene oxide (ii.1.2), and no further initiator, in particular no amine-based initiator, is used. “Amine-based initiator” comprises compounds comprising one or more primary, secondary and/or tertiary amine group(s). This comprises primary amine compounds, such as, for example, ethanolamine, secondary amine compounds, such as diethanolamine, oligoamines with primary amine groups, such as isophoronediamine, diaminotoluene, diaminohexane, diaminodiphenylmethane, diaminodicyclohexylmethane or ethylenediamine, tertiary amine compounds, such as, for example, triethanolamine or triethylamine, or polyamines with primary amine groups.

In one embodiment of the fiber composite material, the ethoxylated polyether polyol (ii.1) is based on a triol, preferably on a triol (ii.1.1) of the formula (I) as described above, and preferably exhibits the formula (II):

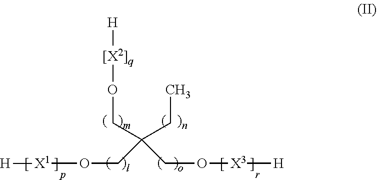

wherein

l, m, n and o are each independently of one another an integer from the range from 1 to 6;

more preferably, l, m, n and o are all 1;

p, q and r are each independently of one another zero or an integer from the range from 1 to 6;

and X¹, X² and X³ are each a —CH₂—CH₂—O— group.

Preferably, the polyol composition (ii) comprises no polyol which is based on an amine-based initiator.

In one embodiment of the fiber composite material, the polyurethane (a) is obtainable or obtained without use of a polyol which is based on an amine-based initiator.

In one embodiment of the fiber composite material, the polyol composition (ii) comprises less than 10% by weight of polyols which exhibit a propylene oxide and/or a butylene oxide end group.

The polyol composition according to (ii) preferably comprises one or more further polyols in addition to the at least one ethoxylated polyether polyol (ii.1), the further polyol(s) being selected from the group of the polyester polyols, more preferably aromatic polyester polyols or oleochemical polyols. The at least one polyester polyol, preferably the aromatic polyester polyol or the oleochemical polyol, preferably exhibits a functionality in the range from 2 to 3, more preferably in the range from 2.4 to 3.

Polyesterols are produced, for example, by polycondensation of aliphatic or aromatic dicarboxylic acid derivatives and polyvalent alcohols, polythioether polyols, polyesteramides, polyacetals containing hydroxyl groups and/or aliphatic polycarbonates containing hydroxyl groups, preferably in the presence of an esterification catalyst. Further possibilities exist in the ring-opening polymerization of cyclic esters (for example ε-caprolactone or hydroxycarboxylic acids, for example co-hydroxycaproic acid) or carbonates and also in the transesterification of polyesterols with polyvalent alcohols. Further possible polyols are, for example, cited in “Kunststoffhandbuch, Band 7, Polyurethane” [Plastics Handbook, Volume 7, Polyurethanes], Carl Hanser Verlag, 3rd Edition, 1993, Chapter 3.1.

Preferably, polyfunctional alcohols, preferably diols with 2 to 12 carbon atoms, more preferably 2 to 6 carbon atoms, are reacted with polyfunctional carboxylic acids with 2 to 12 carbon atoms, for example succinic acid, glutaric acid, adipic acid, suberic acid, azelaic acid, sebacic acid, decanedioic acid, maleic acid, fumaric acid, and preferably phthalic acid, isophthalic acid, terephthalic acid and the isomeric naphthalenedicarboxylic acids. The dicarboxylic acids can be used both individually and in the mixture with one another. It is possible here to carry out the polycondensation in the presence of fatty acids, such as, for example, oleic acid or ricinoleic acid. Examples of divalent or polyvalent alcohols are: ethanediol, diethylene glycol, 1,2- or 1,3-propanediol, dipropylene glycol, 1,4- or 1,2-butanediol, 1,5-pentanediol, 1,6-hexanediol, 1,10-decanediol, glycerol and trimethylolpropane.

The polyesterols preferably have a functionality between 1.8 and 4, preferably 2 to 3, and a number-average molecular weight of 3480 to 3000, preferably 480 to 3000 g/mol.

They furthermore exhibit an acid number of less than 10, preferably of less than 2.

For the production of the polyester polyols, the organic polycarboxylic acids and/or derivatives and polyvalent alcohols can be polycondensed without catalyst or preferably in the presence of esterification catalysts, advantageously in an atmosphere of inert gas, such as, for example, nitrogen, carbon monoxide, helium or argon, in the melt at temperatures of 150 to 250° C., preferably 180 to 220° C., optionally under reduced pressure, down to the desired acid number, which is preferably less than 10, particularly preferably less than 2. In a preferred embodiment, the esterification mixture is polycondensed at the abovementioned temperatures down to an acid number of 80 to 30, preferably 40 to 30, under standard pressure and subsequently under a pressure of less than 500 mbar, preferably 50 to 150 mbar. Suitable as esterification catalysts are, for example, iron, cadmium, cobalt, lead, zinc, antimony, magnesium, titanium and tin catalysts in the form of metals, metal oxides or metal salts. However, the polycondensation can also be carried out in the liquid phase in the presence of diluents and/or entraining agents, such as, for example, benzene, toluene, xylene or chlorobenzene, for removal of the water of condensation by azeotropic distillation. For the production of the polyester polyols, the organic polycarboxylic acids and/or derivatives and polyvalent alcohols are advantageously polycondensed in the molar ratio of 1:1 to 1.8, preferably 1:1.05 to 1.2.

Preferred polyesterols used are aromatic polyesterols and oleochemical polyesterols. Examples of oleochemical polyols are described, inter alia, in M. Ionescu, Chemistry and Technology of Polyols, Rapra, 2005, Chapter 17.1. A hydroxyl-functionalized oleochemical compound, i.e. an oleochemical polyol, is preferably used. There are a number of hydroxyl-functional oleochemical compounds which can be used. Examples are castor oil, oils modified with hydroxyl groups, such as grapeseed oil, black cumin oil, pumpkin seed oil, borage seed oil, soybean oil, wheatgerm oil, rapeseed oil, sunflower oil, peanut oil, apricot kernel oil, pistachio kernel oil, almond oil, olive oil, macadamia nut oil, avocado oil, sea buckthorn oil, sesame oil, hazelnut oil, evening primrose oil, wild rose oil, hemp oil, safflower oil, walnut oil, fatty acid esters modified with hydroxyl groups, which esters are based on myristoleic acid, palmitoleic acid, oleic acid, vaccenic acid, petroselinic acid, gadoleic acid, erucic acid, nervonic acid, linoleic acid, linolenic acid, stearidonic acid, arachidonic acid, timnodonic acid, clupanodonic acid or cervonic acid. In one embodiment of the oleochemical polyol, castor oil (triglyceride mixture) and the derivatives thereof are used. Preferred derivatives are reaction products with alkylene oxides or ketone-formaldehyde resins. The last-named compounds are sold, for example, by Covestro AG under the description Desmophen® 1150. A further preferred group of oleochemical polyols used can be obtained by ring-opening of epoxidized fatty acid esters with simultaneous reaction with alcohols and optionally subsequent further transesterification reactions. The incorporation of hydroxyl groups into oils and fats is primarily achieved by epoxidation of the olefinic double bond comprised in these products, followed by the reaction of the epoxy groups formed with a mono- or polyvalent alcohol. The epoxide ring here becomes a hydroxyl group or, in the case of polyfunctional alcohols, a structure with a higher number of OH groups. Since oils and fats are mostly glycerol esters, the abovementioned reactions are also accompanied by parallel transesterification reactions. The compounds thus obtained preferably have a molecular weight in the range between 500 and 1500 g/mol. Such products are supplied, for example, by BASF (as Sovermol®) or by Altropol Kunststoff GmbH as Neukapol®.

In one embodiment of the compact polyurethane, the polyol composition (ii) comprises optional polyetherols, which are, for example, prepared from epoxides, such as propylene oxide and/or ethylene oxide and/or butylene oxide, with initiator compounds having active hydrogen atoms, such as aliphatic alcohols, phenols, amines, carboxylic acids, water or compounds based on natural substances, such as sucrose, sorbitol or mannitol, with use of a catalyst. Mention may be made here of basic catalysts or double metal cyanide catalysts, such as described, for example, in WO 2006/034800 A1, EP 0090444 B1 or WO 05/090440 A1. Preferably, less than 10% of polyetherols which are obtained by reaction of polyfunctional alcohols with propylene oxide and/or ethylene oxide and/or butylene oxide and exhibit secondary OH groups are comprised in the component (ii).

In addition, the polyol composition according to (ii) can comprise polyol types known to a person skilled in the art, such as polybutadienes, based on radically or anionically polymerized butadienes, acrylate polyols, polysiloxane polyols, polyols obtainable by Mannich condensation, aromatic polyols, for example based on bisphenol A, resorcinol, novolak or melamine. Further possibilities are polytetrahydrofurans or polycaprolactones or copolymers from these starting materials. Further possibilities are polymer polyols, for example based on triols, and particles based on polystyrene, styrene/acrylonitrile or polyacrylate/polymethacrylate. All of these polyol types are known, for example, from M. Ionescu, Chemistry and Technology of Polyols, Rapra, 2005, pp 67-75.

In one embodiment of the compact polyurethane, the polyol composition (ii) comprises optional chain extenders. Use is made, as chain extenders, of substances with a molecular weight of preferably less than 450 g/mol, particularly preferably from 60 to 400 g/mol, chain extenders exhibiting two hydrogen atoms which react with isocyanate groups and crosslinking agents exhibiting three hydrogen atoms which react with isocyanate groups. These can preferably be used individually or in the form of mixtures. Preferably, use is made of diols and/or triols with molecular weights of less than 400, particularly preferably from 60 to 300 and in particular from 60 to 150. Suitable as initiator molecules are, for example, aliphatic, cycloaliphatic and/or araliphatic diols with 2 to 14, preferably 2 to 10, carbon atoms, such as monoethylene glycol, 1,2-propanediol, 1,3-propanediol, 2-methyl-1,3-propanediol, 1,10-decanediol, 1,2-, 1,3- or 1,4-dihydroxycyclohexane, diethylene glycol, dipropylene glycol, tripropylene glycol, 1,4-butanediol, 1,2-butanediol, 1,6-hexanediol and bis(2-hydroxyethyl)hydroquinone (HQEE), bisphenol A bis(hydroxyethyl ether), triols, such as 1,2,4- or 1,3,5-trihydroxycyclohexane, glycerol and trimethylolpropane, and low-molecular-weight polyalkylene oxides containing hydroxyl groups, which polyalkylene oxides are based on ethylene oxide and/or 1,2-propylene oxide and the abovementioned diols and/or triols.

Amine chain extenders, such as, for example, diethyltoluenediamine (DEDTA), m-phenylenediamine, diethanolamine or triethanolamine, are furthermore suitable. Use is particularly preferably made, as chain extenders, of monoethylene glycol, butane-1,4-diol, butane-1,2-diol, diethylene glycol, glycerol or mixtures thereof. If chain extenders and/or crosslinking agents are used, the proportion of the chain extenders and/or crosslinking agents is typically from 1% to 50%, preferably from 2% to 20%, by weight, based on the total weight of the components of the polyol composition (ii). However, it is also possible here to dispense with the chain extenders or crosslinking agents. The addition of chain extenders, crosslinking agents or optionally also mixtures thereof can prove to be advantageous, though, for modifying the mechanical properties, for example the hardness.

In one embodiment of the fiber composite material, the polyol composition (ii) comprises less than 10% by weight of polyols which exhibit an end group based on propylene oxide and/or butylene oxide, the polyol composition (ii) preferably comprising no polyols which exhibit a propylene oxide end group or butylene oxide end group. Preferably, the polyol composition (ii) comprises less than 10% by weight of polyols which exhibit a propylene oxide and/or butylene oxide group. The polyol composition (ii) more preferably comprises no polyols which exhibit a propylene oxide or butylene oxide group and/or no polyols based on propylene oxide and/or butylene oxide and/or no chain extenders with secondary OH groups.

In one embodiment of the fiber composite material, the polyol composition (ii) comprises at least one reactive diluent, preferably at 5% to 50% by weight, based on the total weight of the polyol composition (ii), the at least one reactive diluent preferably comprising a substance with at least one olefinic group, preferably a substance with at least two olefinic groups, more preferably a substance with at least one terminal olefinic group, more preferably at least two terminal olefinic groups. Substances with terminal olefinic groups are preferably selected from the group of allyl ethers; vinyl ethers; acrylates, methacrylates, more preferably from the group of butanediol diacrylate, butanediol dimethacrylate and mixtures of butanediol diacrylate and butanediol dimethacrylate; acrylates based on ethylene glycol, preferably oligomeric or polymeric ethylene glycol acrylates; acrylates based on propylene glycol, preferably oligomeric or polymeric acrylates based on propylene glycol; acrylates based on bisphenol A, acrylates based on bisphenol F, glycerol-based acrylates, oligomeric glycerol-based acrylates, trimethylolpropane-based acrylates, ditrimethylolpropane-based acrylates, pentaerythritol-based acrylates, isocyanurate-based acrylates, hexahydrotriazine-based acrylates, and methacrylates, where each time at least one, preferably more than one, acrylate, methacrylate, allyl ether or vinyl ether group, more preferably each time at least one, more preferably more than one, terminal acrylate, methacrylate, allyl ether or vinyl ether group, is comprised.

In one embodiment of the fiber composite material, the polyurethane comprises an epoxy resin, preferably in 1% to 50% by weight, preferably in 5% to 25% by weight, based each time on the total weight of the polyol composition (ii).

Low-viscosity aliphatic, cycloaliphatic or aromatic epoxides and also the mixtures thereof are particularly well suited as polyepoxides. The polyepoxides can be prepared by reaction of epoxides, for example epichlorohydrin, with alcohols. Bisphenol A, bisphenol F, bisphenol S, cyclohexanedimethanol, phenol-formaldehyde resins, cresol-formaldehyde novolaks, butanediol, hexanediol, trimethylolpropane or polyether polyols, for example, can be used as alcohols. It is also possible to use glycidyl esters, for example of phthalic acid, isophthalic acid or terephthalic acid and also the mixtures thereof. Epoxides can also be produced by the epoxidation of organic compounds comprising double bonds, for example by the epoxidation of fats or oils, such as soybean oil, to give epoxidized soybean oil. The polyepoxides can also comprise monofunctional epoxides as reactive diluents. These can be produced by the reaction of alcohols with epichlorohydrin, for example monoglycidyl ethers of C₄-C₁₈ alcohols, cresol or p-(tert-butyl)phenol. Further polyepoxides which can be used are described, for example, in “Handbook of Epoxy Resins” by Henry Lee and Kris Neville, McGraw-Hill Book Company, 1967. Preference is given to the use of glycidyl ethers of bisphenol A which have an epoxide equivalent weight in the range from 170 to 250 g/eq, particularly preferably with an epoxide equivalent weight in the range from 176 to 196 g/eq. The epoxy equivalent value can be determined according to ASTM D-1652. For example, Eurepox 710 or Epilox 828 can be used for this.

In one embodiment of the fiber composite material, the isocyanate composition (i) and/or the polyol composition (ii), preferably the isocyanate composition (i) and the polyol composition (ii), each exhibit a viscosity at 25° C. of less than 1000 mPa·s, preferably of <500 mPa·s, the viscosity being determined according to ASTM D445 (25° C.).

In one embodiment of the fiber composite material, polyisocyanate composition (i) and polyol composition (ii), preferably polyisocyanate composition (i) and all groups which react with isocyanate, are used in such a ratio that the isocyanate index is between 99 and 400, preferably between 100 and 250. In the context of the present invention, the isocyanate index is understood to mean the stoichiometric ratio of isocyanate groups to groups which react with isocyanate, multiplied by 100. Groups which react with isocyanate are understood to mean in this connection all groups comprised in the reaction mixture which react with isocyanate, including chemical blowing agents and compounds with epoxy groups, but not the isocyanate group itself. The isocyanate index is determined by calculation from the % by weight or the amounts of the components used and their functionalities. In the prior art, it is generally the prevailing opinion that a high isocyanate index increases the risk of undesirable reactions of the isocyanate with atmospheric moisture occurring in the course of production. A person skilled in the art would therefore conventionally select the index such that there is no or only a minimal excess of isocyanate in an open winding process (isocyanate index 100-120). For example, WO 03/085022 A discloses an isocyanate index >120 in the winding process, examples A9, A10, A11, A12, A13 and A14 all comprising only quantitative data but no details regarding processability and foam formation. WO18/036943 A describes a similar chemistry (but not an EO-based crosslinking agent but predominant polyols with sec. OH) to the present invention and gives an index in the range of up to 200 (preferably up to 110) but is not optimized for the fiber winding application. It has surprisingly been found that the polyol composition according to the invention makes it possible to use a high excess of isocyanate of between 99 and 400, preferably between 100 and 250. It could surprisingly be shown that, when the polyol composition according to the invention is used, surprisingly improved properties are also obtained with regard to a higher index—in particular with regard to heat deflection temperature—and the processability/tendency to form bubbles is surprisingly excellent despite the high index.

The ratio of the isocyanate groups to epoxy groups is between 12: 1 and 2:1, preferably between 10: 1 and 4:1.

In one embodiment of the fiber composite material, neither the polyisocyanate composition (i) nor the polyol composition (ii) comprises radical initiators or photoinitiators. In one embodiment of the fiber composite material, radical inhibitors are present. Use may be made, as radical inhibitors, of substances which lead to a termination or to a delay in the radical polymerization of the carbon-carbon double bonds. Radical inhibitors, also referred to as radical scavengers, comprise bis(trifluoromethyl)nitroxide, aminoxyl radicals, 2,2-diphenyl-1-picrylhydrazyl and 2,2,6,6-tetramethylpiperidin-1-yloxy. Preferred radical inhibitors are phenothiazine, nitrobenzene, hydroquinone monomethyl ether, p-benzoquinone and diphenylpicrylhydrazyl. In a preferred embodiment, the reaction mixture comprises from 0.0001% to 2.0% by weight, preferably from 0.0005% to 1.0% by weight and in particular from 0.001% to 0.5% by weight of radical inhibitor, based on the total weight of the components (ii). The radical inhibitors can in principle be added to component (i) and/or to component (ii).

Auxiliaries and/or additives (ii.1.4) can optionally also be used. All auxiliaries and additives known for the production of polyurethanes can be used here. Mention may be made, for example, of surface-active substances, blowing agents, foam stabilizers, cell regulators, deaerators, defoamers, water scavengers, adhesion promoters, wetting agents, flow aids, thixotropic agents, release agents, plasticizers, thinners, fillers, dyes, pigments, flame retardants, additives to suppress smoke formation, hydrolysis inhibitors, antistatic agents, antioxidants, UV protection agents, and fungistatic and bacteriostatic substances. Such substances are known and described, for example in “Kunststoffhandbuch, Band 7, Polyurethane” [Plastics Handbook, Volume 7, Polyurethanes], Carl Hanser Verlag, 3rd

Edition, 1993, Chapters 3.4.4 and 3.4.6 to 3.4.11. A person skilled in the art knows that these additives can be used in the range from 0 to 25 percent by weight, based on the polyol composition.

As additives, conventional polyurethane catalysts can be used as catalysts (ii.1.4). These greatly accelerate the reaction, with the di- and polyisocyanates (a), of the compounds with hydrogen atoms which react with isocyanates (b). Mention may be made, as conventional catalysts which can be used for the production of the polyurethanes, for example, of amidines, such as 2,3-dimethyl-3,4,5,6-tetrahydropyrimidine, or tertiary amines, such as triethylamine, tributylamine, dimethylbenzylamine, dimethylcyclohexylamine, N-methyl-, N-ethyl- or N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropypurea, dimethylpiperazine, 1,2-dimethylimidazole, 1-azabicyclo[3.3.0]octane, and preferably 1,4-diazabicyclo[2.2.2]octane, and alkanolamine compounds, such as triethanolamine, triisopropanolamine, N-methyl- and N-ethyldiethanolamine and dimethylethanolamine. Just as suitable are organic metal compounds, preferably organic tin compounds, such as tin(II) salts of organic carboxylic acids, for example tin(II) acetate, tin(II) octoate, tin(II) ethylhexanoate and tin(II) laurate, and the dialkyltin(IV) salts of organic carboxylic acids, for example dibutyltin diacetate, dibutyltin dilaurate, dibutyltin maleate and dioctyltin diacetate, and also bismuth carboxylates, such as bismuth(III) neodecanoate, bismuth 2-ethylhexanoate and bismuth octanoate, or mixtures thereof. The organic metal compounds can be used alone or preferably in combination with strongly basic amines. If component (ii.1.4) is an ester, exclusively amine catalysts are preferably used. It is also possible to use “latent” catalysts known to a person skilled in the art, which at ambient temperature exhibit no or only a slight catalytic activity and are only activated for example by increasing the temperature. Examples of these catalysts are found, inter alia, in DE 102008021980 A1 or WO 2009/115540 A1.

Catalysts (ii.1.4) can, for example, be used in a concentration of 0.001% to 5% by weight, in particular of 0.05% to 2% by weight, as catalyst or catalyst combination, based on the weight of the component (ii). In a further preferred embodiment, the auxiliaries and additives (ii.1.4) can comprise basic catalysts which are not conventional polyurethane-forming catalysts. These comprise, by way of example, the catalysts which catalyze the formation of polyisocyanurate. Polyisocyanurate catalysts comprise alkali metal carboxylates. These preferably comprise formates and acetates, in particular acetates, such as sodium acetate, potassium acetate and cesium acetate.

In one embodiment of the fiber composite material, the polyisocyanate composition (i) and/or the polyol composition (ii) comprises alkali metal or alkaline earth metal carboxylates. In one embodiment of the fiber composite material, the polyisocyanate composition (i) and/or the polyol composition (ii) comprises an acid-blocked catalyst.

Additives (ii.1.4) of a further type are deaerators, which are known to a person skilled in the art and are described, for example, in Thomas Brock, Michael Groteklaes and Peter Mischke: Lehrbuch der Lacktechnologie [Textbook of Paint Technology], Ed.: Ulrich Zorll, 2nd Edition, Vincentz Verlag, Hanover, 2000, ISBN 978-3-87870-569-7, Chap. 2.4.2.1, Defoamers and Deaerators, pp 169 et seq. In a further embodiment, such components (ii.1.4), which comprise no hydrogen atoms which react with isocyanates, can also be added to the polyisocyanate composition (i).

Some embodiments comprise fillers as additives (ii.1.4). The group of fillers comprises ground minerals, such as metal oxides, aluminum hydroxide, bentonites, perlite, fly ash, alkaline earth metal carbonates, such as, for example, calcium carbonate, talc, mica, kaolin, wollastonite, quartz powder, kieselguhr, pyrogenic silica, barium sulfate, calcium sulfate, glass microspheres, hollow glass microspheres, graphite or soot. Also comprised are fillers of biological origin, such as, for example, wood fibers, wood chips, bamboo fibers, bamboo chips, straw, flax or cellulose fibers.

Within the meaning of the invention, the term “polyurethane” comprises all known polyisocyanate polyaddition products. These comprise addition products of isocyanate and alcohol, and also modified polyurethanes, which can comprise isocyanurate, allophanate, urea, carbodiimide, uretonimine or biuret structures, and other isocyanate addition products.

In one embodiment of the fiber composite material, the material of the fibers (b) is selected from the group of glass fibers, carbon fibers, polyester fibers, polyethylene fibers, natural fibers, such as cellulose fibers, aramid fibers, nylon fibers, basalt fibers, boron fibers, Zylon fibers (poly(p-phenylene-2,6-benzobisoxazole)), silicon carbide fibers, asbestos fibers, metal fibers and combinations thereof. More preferably, they are usually glass fibers or carbon fibers. In the context of the present invention, the term “fiber(s)” means preferably continuous fibers, which are used as individual fibers or bundled, in particular in the form of so-called “rovings”, i.e. as bundles, strands or multifilament yarns made of filaments arranged essentially in parallel (continuous fibers). The cross section of a roving is preferably elliptical or rectangular, elliptical also comprising the round shape. Use is preferably made of rovings with a fineness in the range from 100 to 10 000 tex, preferably in the range from 1000 to 5000 tex, more preferably in the range from 1500 to 3000 tex. Techniques for wetting the fibers are not limited and are generally known. These comprise, for example, the fiber winding process, the pultrusion process, the hand lamination process and the infusion process, preferably as vacuum infusion process, and also the fiber spraying process. The use of short or long glass fibers, continuous fibers, non-crimp fabrics, warp-knitted fabrics, weft-knitted fabrics, woven fabrics, braids, nonwovens, mats, for example randomly distributed fiber mats, and the like, can be supplemented. Plies with the same or different fiber orientation are possible in this connection, such as, for example, unidirectional and/or multidirectional,

Process for the Production of a Fiber Composite Material

The invention further relates to a process for the production of a fiber composite material, in particular for the production of a fiber composite material as described above, comprising the stages:

A) providing a polyisocyanate composition (i);

B) providing a polyol composition (ii) comprising at least 15% by weight, preferably at least 20% by weight, more preferably at least 25% by weight, more preferably at least 30% by weight, of an at least trifunctional alcohol (ii.1), which exhibits at least two primary hydroxyl groups, preferably three primary hydroxyl groups;

C) mixing polyisocyanate composition (i) and polyol composition (ii) to obtain a polyurethane reaction mixture (a′);

D) reacting the polyurethane reaction mixture (a′) in the presence of fibers (b) to give the polyurethane (a), the fibers (b) being at least partially embedded in the polyurethane reaction mixture (a′) or in the polyurethane (a), to obtain a fiber composite material.

In one embodiment, the process for the production of a fiber composite material comprises the stages:

A) providing a polyisocyanate composition (i);

B) providing a polyol composition (ii) comprising at least 15% by weight, preferably at least 20% by weight, more preferably at least 25% by weight, more preferably at least 30% by weight, of an ethoxylated polyether polyol (ii.1);

C) mixing polyisocyanate composition (i) and polyol composition (ii) to obtain a polyurethane reaction mixture (a′);

D) reacting the polyurethane reaction mixture (a′) in the presence of fibers (b) to give the polyurethane (a), the fibers (b) being at least partially embedded in the polyurethane reaction mixture (a′) or in the polyurethane (a), to obtain a fiber composite material.

Details or specific embodiments regarding the polyisocyanate composition (i), the at least trifunctional alcohol (ii.1), which exhibits at least two primary hydroxyl groups, preferably three primary hydroxyl groups, and also further components of the polyol composition (ii), and also the fibers (b), are already described above in connection with the fiber composite material itself and apply here accordingly to the manufacturing process.

In one embodiment, the process for the production of a fiber composite material comprises the stages:

A) providing a polyisocyanate composition (i);

B) providing a polyol composition (ii) comprising at least 15% by weight, preferably 20% by weight, more preferably at least 25% by weight, more preferably at least 30% by weight, of an ethoxylated polyether polyol (ii.1);

C) mixing polyisocyanate composition (i) and polyol composition (ii) to obtain a polyurethane reaction mixture (a′);

D.1) reacting the polyurethane reaction mixture (a′) in the presence of fibers (b) to give a prepolymerized polyurethane (a), the fibers (b) being at least partially embedded in the polyurethane reaction mixture (a′) or in the polyurethane (a), to obtain a laminate;

E) optional shaping of the laminate produced in stage D.1), it being possible for one or more of the laminates produced in stage D.1) to be used and consolidated for this purpose;

F) complete curing of the laminate according to D.1) or of the shaped laminate(s) according to E).

In one embodiment, the process for the production of a fiber composite material comprises the stages:

A) providing a polyisocyanate composition (i);

B) providing a polyol composition (ii) comprising at least 15% by weight, preferably 20% by weight, more preferably at least 25% by weight, more preferably at least 30% by weight, of an ethoxylated polyether polyol (ii.1);

C) mixing polyisocyanate composition (i) and polyol composition (ii) to obtain a polyurethane reaction mixture (a′);

D.2) reacting the polyurethane reaction mixture (a′) to give a prepolymerized polyurethane (a),

E) reacting the prepolymerized polyurethane (a) in the presence of fibers (b), the fibers (b) being at least partially embedded in the polyurethane reaction mixture (a′) or in the polyurethane (a), to obtain a laminate;

F) optional shaping of the laminate produced in stage E), it being possible for one or more of the laminates produced in stage D.1) to be used and consolidated for this purpose;

G) complete curing of the laminate according to E) or of the shaped laminate(s) according to F).

In one embodiment of the process for the production of a fiber composite material, the ethoxylated polyether polyol (ii.1) is obtained or obtainable by reaction of:

ii.1.1) a polyol initiator with a functionality of 3 to 6, preferably 3 or 4,

with

ii.1.2) ethylene oxide,

in the presence of an alkoxylation catalyst (ii.1.3);

ii.1.4) optionally further auxiliaries and/or additives.

In one embodiment of the process for the production of a fiber composite material, the ethoxylated polyether polyol (ii.1) exhibits a hydroxyl number of more than 300 mg KOH/g, preferably of more than 450 mg KOH/g, more preferably a hydroxyl number in the range from 300 to 1400 mg KOH/g, more preferably in the range from 450 to 1300 mg KOH/g, more preferably in the range from 450 to 1260 mg KOH/g.

In one embodiment of the process for the production of a fiber composite material, the ethoxylated polyether polyol (ii.1) exhibits an equivalent molecular weight of less than 200 g/mol, preferably in the range from 50 to 140 g/mol, more preferably in the range from 55 to 135 g/mol, more preferably in the range from 60 to 130 g/mol.

In one embodiment of the process for the production of a fiber composite material, the ethoxylated polyether polyol (ii.1) is used in 20% to 100% by weight, preferably in 25% to 75% by weight, more preferably in 30% to 50% by weight, based on a total weight of the polyol composition (ii) of 100% by weight.

In one embodiment of the process for the production of a fiber composite material, the ethoxylated polyether polyol (ii.1) exhibits no end groups based on propylene oxide and/or end groups based on butylene oxide, preferably exhibits exclusively end groups based on ethylene oxide. In one embodiment of the process for the production of a fiber composite material, the ethoxylated polyether polyol (ii.1) exhibits exclusively groups based on ethylene oxide and comprises no groups based on propylene oxide and/or groups based on butylene oxide.

In one embodiment of the process for the production of a fiber composite material, the polyol initiator (ii.1.1) of the ethoxylated polyether polyol (ii.1) comprises a triol with a functionality of 3, preferably a triol of the formula (I):

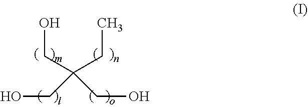

where l, m, n and o are each independently of one another an integer from the range from 1 to 6. Preferably, l, m, n and o of the at least one triol (ii.1.1) of the formula (I) are each independently of one another an integer from the range from 1 to 3; preferably, l, m, n and o are all 1. The triol (ii.1.1) preferably exhibits a hydroxyl number in the range from 200 to 2000 mg KOH/g, preferably in the range from 250 to 1850 mg KOH/g, more preferably in the range from 300 to 1850 mg KOH/g.

In one embodiment of the process for the production of a fiber composite material, the ethoxylated polyether polyol (in) is produced only by the reaction of a polyol initiator (ii.1.1.), in particular a triol of the formula (I), and ethylene oxide (ii.1.2), and no further alkylene oxide is used.

In one embodiment of the process for the production of a fiber composite material, the ethoxylated polyether polyol (in) is produced only by the reaction of a polyol initiator (ii.1.1.), in particular triol of the formula (I), and ethylene oxide (ii.1.2), and no further initiator, in particular no amine-based initiator, is used.

In one embodiment of the process for the production of a fiber composite material, the ethoxylated polyether polyol (in) is based on a triol, preferably on a triol (ii.1.1) of the formula (I) as described above. and more preferably exhibits the formula (II):

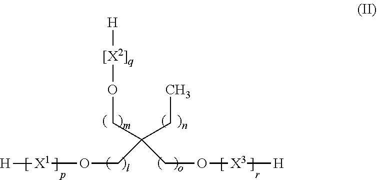

wherein

l, m, n and o are each independently of one another an integer from the range from 1 to 6; more preferably, l, m, n and o are all 1;

p, q and r are each independently of one another zero or an integer from the range from 1 to 6;

and X¹, X² and X³ are each a —CH₂—CH₂—O— group.

In one embodiment of the process for the production of a fiber composite material, the polyol composition (ii) comprises no polyol which is based on an amine-based initiator.

In one embodiment of the process for the production of a fiber composite material, the polyurethane (a) is obtainable or obtained without use of a polyol which is based on an amine-based initiator.

In one embodiment of the process for the production of a fiber composite material, the polyol composition (ii) comprises less than 10% by weight of polyols which exhibit a propylene oxide and/or a butylene oxide end group. In one embodiment of the process for the production of a fiber composite material, the polyol composition (ii) comprises one or more further polyol(s), preferably at least one polyester polyol, more preferably an aromatic polyester polyol or an oleochemical polyol. The at least one polyester polyol, preferably the aromatic polyester polyol or the oleochemical polyol, preferably exhibits a functionality in the range from 2 to 3, more preferably in the range from 2.4 to 3. Details on the polyester polyols used or the preferred aromatic polyester polyols or the preferred oleochemical polyols have already been described at the outset in the section on the fiber composite material; the details described there also apply to the process. In one embodiment of the process for the production of a fiber composite material, the polyol composition (ii) comprises no polyols which exhibit a propylene oxide end group or butylene oxide end group. In one embodiment of the process for the production of a fiber composite material, the polyol composition (ii) comprises less than 10% by weight of polyols which exhibit a propylene oxide and/or butylene oxide group. In one embodiment of the process for the production of a fiber composite material, the polyol composition (ii) comprises no polyols which exhibit a propylene oxide or butylene oxide group.

In one embodiment of the process for the production of a fiber composite material, the polyol composition (ii) comprises at least one reactive diluent, the at least one reactive diluent preferably comprising a substance with at least one olefinic group, preferably a substance with at least two olefinic groups, more preferably a substance with at least one terminal olefinic group, more preferably at least two terminal olefinic groups.

In one embodiment of the process for the production of a fiber composite material, the polyurethane comprises an epoxy resin, preferably in 1% to 50% by weight, preferably in 5% to 25% by weight, based each time on the total weight of the polyol composition (ii).

In one embodiment of the process for the production of a fiber composite material, the isocyanate composition (i) and/or the polyol composition (ii), preferably the isocyanate composition (i) and the polyol composition (ii), each exhibit a viscosity at 25° C. of less than 1000 mPa·s, preferably of <500 mPa·s, the viscosity being determined according to ASTM D445 (25° C.).

In one embodiment of the process for the production of a fiber composite material, polyisocyanate composition (i) and polyol composition (ii), preferably polyisocyanate composition (i) and all groups which react with isocyanate, are used in such a ratio that the isocyanate index is between 99 and 400, preferably between 100 and 250.

In one embodiment of the process for the production of a fiber composite material, apart from polyisocyanate composition (i), polyol composition (ii) and the fibers (b), no further components are added after the mixing of (i) and (II) or after the addition of (b).

In one embodiment of the process for the production of a fiber composite material, neither polyisocyanate composition (i) nor polyol composition (ii) comprises urethane, urea, amide, biuret, allophanate or isocyanurate groups. In one embodiment of the process for the production of a fiber composite material, the polyisocyanate composition (i) comprises an isocyanate prepolymer.

In one embodiment of the process for the production of a fiber composite material, further auxiliaries and/or additives (ii.1.4) are added, the further auxiliaries and/or additives preferably being comprised in the polyol composition (ii), more preferably the at least trifunctional alcohol (ii.1), which exhibits at least two primary hydroxyl groups, preferably three primary hydroxyl groups, more preferably the ethoxylated polyether polyol (ii.1) which comprises further auxiliaries and/or additives, more preferably the ethoxylated polyether polyol (ii.1) is obtained or obtainable by reaction of a polyol initiator (ii.1.1) with a functionality of 3 to 6, preferably 3 or 4, with ethylene oxide (ii.1.2), in the presence of an alkoxylation catalyst (ii.1.3) and the further auxiliaries and/or additives (ii.1.4). In one embodiment of the process for the production of a fiber composite material, further auxiliaries and/or additives are added, the further auxiliaries and/or additives preferably being comprised in the isocyanate composition (i). Further details on the further auxiliaries and/or additives (ii.1.4) have already been described at the outset for the fiber composite material and apply here correspondingly to the production process.

In one embodiment, the process for the production of a fiber composite material is carried out using the fiber winding process by mixing the polyisocyanate composition (i) and the polyol composition (ii), metering them into an impregnation bath and bringing them into contact there with the fibers (b), the impregnated fibers subsequently being placed on a winding spindle, a tool or a component.

The impregnation bath is executed according to WO 19/025439 A1. The bath is connected directly to the mixing head of the dosing system and can be temperature-controlled. The resin capacity of the impregnation bath is dimensioned in such a way that as little resin as possible can be worked and that frequent exchange several times per minute takes place. The resin consumption per minute can be easily calculated from the number, the density and the tex count of the fibers, the desired fiber volume content, the density of the resin and the speed at which the fibers are drawn through the bath. The geometry of the bath is chosen in such a way that no dead zones are produced in which resin can accumulate. Furthermore, the possibility is allowed for of adding a cleaning liquid or compressed air to the impregnation bath, without the impregnation bath having to be dismantled for this purpose.

In one embodiment, the process for the production of a fiber composite material is carried out using the long fiber injection process, by mixing the polyisocyanate composition (i) and the polyol composition (ii), trickling cut fibers (b) into the reaction mixture, preferably at the mixing head, then spraying the material into a mold and/or onto a support and subsequently curing there. In one embodiment, the process for the production of a fiber composite material is carried out using the fiber spraying process, by mixing the polyisocyanate composition (i) and the polyol composition (ii), spraying the reaction mixture onto fibers and subsequently curing it. In one embodiment, the process for the production of a fiber composite material is carried out using the pultrusion process by mixing the polyisocyanate composition (i) and the polyol composition (ii), metering the reaction mixture into a closed impregnation device, in which it comes into contact with continuous oriented fibers and/or fiber mats (b), which are continuously drawn through a mold and then cured. In one embodiment, the process for the production of a fiber composite material takes place using the RTM process, by mixing the polyisocyanate composition (i) and the polyol composition (ii), metering them into an at least partially evacuated mold, in which a preform made of fibers (b) was inserted beforehand, and subsequently curing in the mold.

In one embodiment, the process for the production of a fiber composite material for the production of an SMC (sheet molding compound) takes place by mixing the polyisocyanate composition (i) and the polyol composition (ii), applying them to at least one of two carrier films, bringing them into contact with reinforcing fibers, bringing the two carrier films together to form a sandwich and rolling them, the SMC optionally being stored cut in stacks or rolled up, one or more of the SMC parts optionally after removal of the carrier film being consolidated and cured in a pressing tool to form the component.

In one embodiment, the process for the production of a fiber composite material takes place for the production of fibers or textiles preimpregnated with polyurethane (polyurethane prepregs).

According to WO 2014/170252 A1, it is preferred, for the production of polyurethane-based prepregs, to use polyols with a high proportion of secondary OH end groups (40-100%) using latent catalysts. According to WO 2014/170252 Al and WO 2018/219756 A1, it is advantageous or necessary to use, for this purpose, a prepolymer containing isocyanate groups which is heated to 90° C. and is then impregnated with the fibers. According to the process according to the invention, preferably at least 30% by weight of an ethoxylated polyether polyol can be used for the production of prepregs. In this connection, according to one embodiment, the polyisocyanate composition (i) and the polyol composition (ii) can be mixed, brought into contact with the oriented fibers (b) and subsequently partially cured. According to one embodiment, the polyisocyanate composition (i) and the polyol composition (ii) are mixed and reacted at a temperature below 80° C. The prereacted mixture is then brought into contact with the oriented fibers (b) and subsequently partially cured. According to both embodiments, the prepreg material (optionally after shaping and consolidating with further plies of prepreg, for example in a press) is heated to 150° C. for 3 minutes to 3 hours for the final curing.

The process according to the invention is then particularly advantageous if a production process for the fiber composite material is selected in which long open times (>30 minutes) are required and the reaction material is in direct contact with the surrounding atmosphere over a relatively long period of time, for example when using open impregnation baths or in the production of prepregs.

The invention further relates to a fiber composite material obtained or obtainable by the process described above.

The invention further relates to the use of a fiber composite material as described above or of a fiber composite material obtained or obtainable by the process described above for the production of a pipe, in particular a conical pipe, a pipe connector, a pressure vessel, a storage tank, an insulator, a mast, a bar, a roller, a torsion shaft, a profile, a piece of sports equipment, a molded part, a cover, an automotive exterior part, a rope, a cable, an isogrid structure or a semi-finished textile product.

The present invention has been illustrated in more detail by the following embodiments and combinations of embodiments which result from the corresponding back references and other references. In particular, it should be noted that in every case in which a range of embodiments is mentioned, for example in the context of an expression such as “the process according to any of embodiments 1 to 4”, each embodiment in this range is deemed to be explicitly disclosed to a person skilled in the art, i.e. the wording of this expression is to be understood by a person skilled in the art as synonymous with “the process according to any of embodiments 1, 2, 3 and 4”. Furthermore, it is noted that the following set of embodiments is not the set of claims which determines the scope of protection, but rather constitutes a suitably structured part of the description directed to general and preferred aspects of the invention.

1. A fiber composite material comprising the following components:
a) a polyurethane obtained or obtainable by reaction of at least the components:
   i) a polyisocyanate composition;
   ii) a polyol composition comprising at least 15% by weight, preferably at least 20% by weight, more preferably at least 25% by weight, more preferably at least 30% by weight, of an at least trifunctional alcohol (ii.1), which exhibits at least two primary hydroxyl groups, preferably three primary hydroxyl groups;
b) fibers which are at least partially embedded in the compact polyurethane.

2. The fiber composite material according to embodiment 1, comprising the following components:
a) a polyurethane obtained or obtainable by reaction of at least the components:
   i) a polyisocyanate composition;
   ii) a polyol composition comprising at least 15% by weight, preferably at least 20% by weight, more preferably at least 25% by weight, more preferably at least 30% by weight, of an ethoxylated polyether polyol (ii.1);
b) fibers which are at least partially embedded in the compact polyurethane.

3. The fiber composite material according to embodiment 2, wherein the ethoxylated polyether polyol (ii.1) is obtained or obtainable by reaction of:
ii.1.1) a polyol initiator with a functionality of 3 to 6, preferably 3 or 4,
with
ii.1.2) ethylene oxide,
in the presence of an alkoxylation catalyst (ii.1.3);
ii.1.4) optionally further auxiliaries and/or additives.

4. The fiber composite material according to embodiment 2 or 3, wherein the ethoxylated polyether polyol (ii.1) exhibits a hydroxyl number of more than 300 mg KOH/g, preferably of more than 450 mg KOH/g, more preferably a hydroxyl number in the range from 300 to 1400 mg KOH/g, more preferably in the range from 450 to 1300 mg KOH/g, more preferably in the range from 450 to 1260 mg KOH/g.

5. The fiber composite material according to any of embodiments 2 to 4, wherein the ethoxylated polyether polyol (ii.1) exhibits an equivalent molecular weight of less than 200 g/mol, preferably in the range from 50 to 140 g/mol, more preferably in the range from 55 to 135 g/mol, more preferably in the range from 60 to 130 g/mol.

6. The fiber composite material according to any of embodiments 2 to 5, wherein the ethoxylated polyether polyol (ii.1) is used in 15% to 100% by weight, preferably in 20% to 100% by weight, more preferably in 25% to 75% by weight, more preferably in 30% to 50% by weight, based on a total weight of the polyol composition (ii) of 100% by weight.

7. The fiber composite material according to any of embodiments 2 to 6, wherein the ethoxylated polyether polyol (ii.1) exhibits no end groups based on propylene oxide and/or end groups based on butylene oxide, preferably exhibits exclusively end groups based on ethylene oxide.

8. The fiber composite material according to any of embodiments 2 to 7, wherein the ethoxylated polyether polyol (ii.1) exhibits exclusively groups based on ethylene oxide and comprises no groups based on propylene oxide and/or groups based on butylene oxide.

9. The fiber composite material according to any of embodiments 2 to 8, wherein the polyol initiator (ii.1.1) of the ethoxylated polyether polyol (ii.1) comprises a triol with a functionality of 3, preferably a triol of the formula (I):

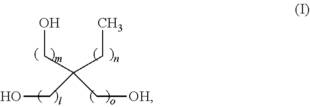

where l, m, n and o are each independently an integer from the range from 1 to 6.

10. The fiber composite material according to embodiment 9, wherein l, m, n and o of the at least one triol (ii.1.1) of the formula (I) are each independently of one another an integer from the range from 1 to 3; preferably, l, m, n and o are all 1.

11. The fiber composite material according to embodiment 9 or 10, wherein the triol (ii.1.1) exhibits a hydroxyl number in the range from 200 to 2000 mg KOH/g, preferably in the range from 250 to 1850 mg KOH/g, more preferably in the range from 300 to 1850 mg KOH/g.

12. The fiber composite material according to any of embodiments 2 to 11, wherein the ethoxylated polyether polyol (ii.1) is produced only by the reaction of a polyol initiator (ii.1.1.), in particular a triol of the formula (I), and ethylene oxide (ii.1.2), and no further alkylene oxide is used.

13. The fiber composite material according to any of embodiments 2 to 12, wherein the ethoxylated polyether polyol (ii.1) is produced only by the reaction of a polyol initiator (ii.1.1.), in particular triol of the formula (I), and ethylene oxide (ii.1.2), and no further starter, in particular no amine-based starter, is used.

14. The fiber composite material according to any of embodiments 2 to 13, wherein the ethoxylated polyether polyol (ii.1) is based on a triol, preferably on a triol (ii.1.1) of the formula (I) according to any of embodiments 8 to 10, and more preferably exhibits the formula (II):

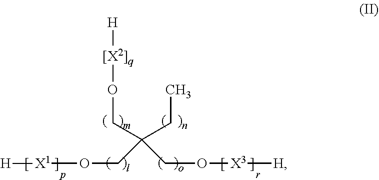

where

l, m, n and o are each independently of one another an integer from the range from 1 to 6; more preferably, l, m, n and o are all 1;
p, q and r are each independently of one another zero or an integer from the range from 1 to 6;
and X¹, X² and X³ are each a —CH₂—CH₂—O— group.

15. The fiber composite material according to any of embodiments 1 to 14, wherein the polyol composition (ii) comprises no polyol which is based on an amine-based initiator.

16. The fiber composite material according to any of embodiments 1 to 15, wherein the polyurethane (a) is obtainable or obtained without use of a polyol which is based on an amine-based initiator.

17. The fiber composite material according to any of embodiments 1 to 16, wherein the polyol composition (ii) comprises less than 10% by weight of polyols which exhibit a propylene oxide and/or a butylene oxide end group.

18. The fiber composite material according to any of embodiments 1 to 17, wherein the polyol composition (ii) comprises one or more further polyol(s), preferably at least one polyester polyol, more preferably an aromatic polyester polyol or a oleochemical polyol, the at least one polyester polyol, preferably the aromatic polyester polyol or the oleochemical polyol, preferably exhibiting a functionality in the range from 2 to 3, more preferably in the range from 2.4 to 3.

19. The fiber composite material according to any of embodiments 1 to 18, wherein the polyol composition (ii) comprises less than 10% by weight of polyols which exhibit an end group based on propylene oxide and/or butylene oxide, the polyol composition (ii) preferably comprising no polyols which exhibit a propylene oxide end group or butylene oxide end group.

20. The fiber composite material according to any of embodiments 1 to 19, wherein the polyol composition (ii) comprises less than 10% by weight of polyols which exhibit a propylene oxide and/or butylene oxide group.

21. The fiber composite material according to any of embodiments 1 to 20, wherein the polyol composition (ii) comprises no polyols which exhibit a propylene oxide or butylene oxide group and/or wherein the polyol composition (ii) comprises no polyols based on propylene oxide and/or butylene oxide.

22. The fiber composite material according to any of embodiments 1 to 21, wherein the polyol composition (ii) comprises at least one reactive diluent, preferably at 5% to 50% by weight, based on the total weight of the polyol composition (ii), the at least one reactive diluent preferably comprising a substance with at least one olefinic group, preferably a substance with at least two olefinic groups, more preferably a substance with at least one terminal olefinic group, more preferably at least two terminal olefinic groups.

23. The fiber composite material according to any of embodiments 1 to 22, wherein the polyurethane comprises an epoxy resin.

24. The fiber composite material according to embodiment 23, wherein the polyurethane comprises the epoxy resin in 1% to 50% by weight, preferably in 5% to 25% by weight, based each time on the total weight of the polyol composition (ii).

25. The fiber composite material according to any of embodiments 1 to 24, wherein the isocyanate composition (i) exhibits a viscosity at 25° C. of less than 1000 mPa·s, preferably of <500 mPa·s (ASTM D445 (25° C.)).

26. The fiber composite material according to any of embodiments 1 to 25, wherein polyisocyanate composition (i) and polyol composition (ii), preferably polyisocyanate composition (i) and all groups which react with isocyanate, are used in such a ratio that the isocyanate index is between 99 and 400, preferably between 100 and 250.

27. The fiber composite material according to any of embodiments 1 to 26, wherein neither the polyisocyanate composition (i) nor the polyol composition (ii) comprises radical initiators or photoinitiators.

28. The fiber composite material according to any of embodiments 1 to 27, wherein the polyisocyanate composition (i) and/or the polyol composition (ii) comprises alkali metal or alkaline earth metal carboxylates.

29. The fiber composite material according to any of embodiments 1 to 28, wherein the polyisocyanate composition (i) and/or the polyol composition (ii) comprises an acid-blocked catalyst.

30. The fiber composite material according to any of embodiments 1 to 29, wherein the viscosity of the polyol composition (ii) is less than 1000 mPa·s, preferably less than 500 mPa·s (ASTM D445 (25° C.)).

31. A process for the production of a fiber composite material, in particular for the production of a fiber composite material according to any of embodiments 1 to 30, comprising the stages:
A) providing a polyisocyanate composition (i);
B) providing a polyol composition (ii) comprising at least 15% by weight, preferably at least 20% by weight, more preferably at least 25% by weight, more preferably at least 30% by weight, of an at least trifunctional alcohol (ii.1), which exhibits at least two primary hydroxyl groups, preferably three primary hydroxyl groups;
C) mixing polyisocyanate composition (i) and polyol composition (ii) to obtain a polyurethane reaction mixture (a′);
D) reacting the polyurethane reaction mixture (a′) in the presence of fibers (b) to give the polyurethane (a), the fibers (b) being at least partially embedded in the polyurethane reaction mixture (a′) or in the polyurethane (a), to obtain a fiber composite material.
32. The process for the production of a fiber composite material according to embodiment 31, in particular for the production of a fiber composite material according to any of embodiments 1 to 30, comprising the stages:
A) providing a polyisocyanate composition (i);
B) providing a polyol composition (ii) comprising at least 15% by weight, preferably at least 20% by weight, more preferably at least 25% by weight, more preferably at least 30% by weight, of an ethoxylated polyether polyol (ii.1);
C) mixing polyisocyanate composition (i) and polyol composition (ii) to obtain a polyurethane reaction mixture (a′);
D) reacting the polyurethane reaction mixture (a′) in the presence of fibers (b) to give the polyurethane (a), the fibers (b) being at least partially embedded in the polyurethane reaction mixture (a′) or in the polyurethane (a), to obtain a fiber composite material.

33. The process for the production of a fiber composite material according to embodiment 32, comprising the stages:
A) providing a polyisocyanate composition (i);
B) providing a polyol composition (ii) comprising at least 15% by weight, preferably at least 20% by weight, more preferably at least 25% by weight, more preferably at least 30% by weight, of an ethoxylated polyether polyol (ii.1); mixing polyisocyanate composition (i) and polyol composition (ii) to obtain a polyurethane reaction mixture (a′);
D.1) reacting the polyurethane reaction mixture (a′) in the presence of fibers (b) to give a prepolymerized polyurethane (a), the fibers (b) being at least partially embedded in the polyurethane reaction mixture (a′) or in the polyurethane (a), to obtain a laminate;
E) optional shaping of the laminate produced in stage D.1), it being possible for one or more of the laminates produced in stage D.1) to be used and consolidated for this purpose;
F) complete curing of the laminate according to D.1) or of the shaped laminate(s) according to E).

34. The process for the production of a fiber composite material according to embodiment 32, comprising the stages:
A) providing a polyisocyanate composition (i);
B) providing a polyol composition (ii) comprising at least 15% by weight, preferably at least 20% by weight, more preferably at least 25% by weight, more preferably at least 30% by weight, of an ethoxylated polyether polyol (ii.1);
C) mixing polyisocyanate composition (i) and polyol composition (ii) to obtain a polyurethane reaction mixture (a′);
D.2) reacting the polyurethane reaction mixture (a′) to give a prepolymerized polyurethane (a),
E) reacting the prepolymerized polyurethane (a) in the presence of fibers (b), the fibers (b) being at least partially embedded in the polyurethane reaction mixture (a′) or in the polyurethane (a), to obtain a laminate;
F) optional shaping of the laminate produced in stage E), it being possible for one or more of the laminates produced in stage D.1) to be used and consolidated for this purpose;
G) complete curing of the laminate according to E) or of the shaped laminate(s) according to F).

35. The process for the production of a fiber composite material according to any of embodiments 32 to 34, wherein the ethoxylated polyether polyol (ii.1) is obtained or obtainable by reaction of:
ii.1.1) a polyol initiator with a functionality of 3 to 6, preferably 3 or 4,
with
ii.1.2) ethylene oxide,
in the presence of an alkoxylation catalyst (ii.1.3);
ii.1.4) optionally further auxiliaries and/or additives.

36. The process for the production of a fiber composite material according to any of embodiments 32 to 35, wherein the ethoxylated polyether polyol (ii.1) exhibits a hydroxyl number of more than 300 mg KOH/g, preferably of more than 450 mg KOH/g, more preferably a hydroxyl number in the range from 300 to 1400 mg KOH/g, more preferably in the range from 450 to 1300 mg KOH/g, more preferably in the range from 450 to 1260 mg KOH/g.

37. The process for the production of a fiber composite material according to any of embodiments 32 to 36, wherein the ethoxylated polyether polyol (ii.1) exhibits an equivalent molecular weight of less than 200 g/mol, preferably in the range from 50 to 140 g/mol, more preferably in the range from 55 to 135 g/mol, more preferably in the range from 60 to 130 g/mol.

38. The process for the production of a fiber composite material according to any of embodiments 32 to 37, wherein the ethoxylated polyether polyol (ii.1) is used in 15% to 100% by weight, preferably in 20% to 100% by weight, more preferably in 25% to 75% by weight, more preferably in 30% to 50% by weight, based on a total weight of the polyol composition (ii) of 100% by weight.

39. The process for the production of a fiber composite material according to any of embodiments 32 to 38, wherein the ethoxylated polyether polyol (ii.1) exhibits no end groups based on propylene oxide and/or end groups based on butylene oxide, preferably exhibits exclusively end groups based on ethylene oxide.

40. The process for the production of a fiber composite material according to any of embodiments 32 to 39, wherein the ethoxylated polyether polyol (ii.1) exhibits exclusively groups based on ethylene oxide and comprises no groups based on propylene oxide and/or groups based on butylene oxide.

41. The process for the production of a fiber composite material according to any of embodiments 32 to 40, wherein the polyol initiator (ii.1.1) of the ethoxylated polyether polyol (ii.1) comprises a triol with a functionality of 3, preferably a triol of the formula (I):

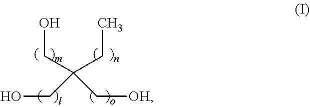

where l, m, n and o are each independently an integer from the range from 1 to 6.

42. The process for the production of a fiber composite material according to embodiment 41, wherein l, m, n and o of the at least one triol (ii.1.1) of the formula (I) are each independently of one another an integer from the range from 1 to 3; preferably, l, m, n and o are all 1.

43. The process for the production of a fiber composite material according to embodiment 41 or 42, wherein the triol (ii.1.1) exhibits a hydroxyl number in the range from 200 to 2000 mg KOH/g, preferably in the range from 250 to 1850 mg KOH/g, more preferably in the range from 300 to 1850 mg KOH/g.

44. The process for the production of a fiber composite material according to any of embodiments 32 to 43, wherein the ethoxylated polyether polyol (ii.1) is produced only by the reaction of a polyol initiator (ii.1.1.), in particular a triol of the formula (I), and ethylene oxide (ii.1.2), and no further alkylene oxide is used.

45. The process for the production of a fiber composite material according to any of embodiments 32 to 44, wherein the ethoxylated polyether polyol (ii.1) is produced only by the reaction of a polyol initiator (ii.1.1.), in particular triol of the formula (I), and ethylene oxide (ii.1.2), and no further starter, in particular no amine-based starter, is used.

46. The process for the production of a fiber composite material according to any of embodiments 32 to 45, wherein the ethoxylated polyether polyol (ii.1) is based on a triol, preferably on a triol (ii.1.1) of the formula (I) according to any of embodiments 8 to 10, and more preferably exhibits the formula (II):

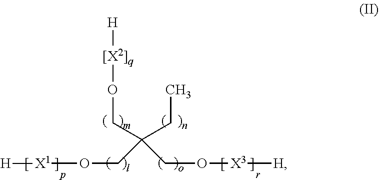

where
l, m, n and o are each independently of one another an integer from the range from 1 to 6; more preferably, l, m, n and o are all 1;
p, q and r are each independently of one another zero or an integer from the range from 1 to 6;
and X¹, X² and X³ are each a —CH₂—CH₂—O— group.

47. The process for the production of a fiber composite material according to any of embodiments 31 to 46, wherein the polyol composition (ii) comprises no polyol which is based on an amine-based initiator.

48. The process for the production of a fiber composite material according to any of embodiments 31 to 47, wherein the polyurethane (a) is obtainable or obtained without use of a polyol which is based on an amine-based initiator.

49. The process for the production of a fiber composite material according to any of embodiments 31 to 48, wherein the polyol composition (ii) comprises less than 10% by weight of polyols which exhibit a propylene oxide and/or a butylene oxide end group.

50. The process for the production of a fiber composite material according to any of embodiments 31 to 49, wherein the polyol composition (ii) comprises one or more further polyol(s), preferably at least one polyester polyol, more preferably an aromatic polyester polyol or a oleochemical polyol, the at least one polyester polyol, preferably the aromatic polyester polyol or the oleochemical polyol, preferably exhibiting a functionality in the range from 2 to 3, more preferably in the range from 2.4 to 3.

51. The process for the production of a fiber composite material according to any of embodiments 31 to 48, wherein the polyol composition (ii) comprises no polyols which exhibit a propylene oxide end group or butylene oxide end group.

52. The process for the production of a fiber composite material according to any of embodiments 31 to 51, wherein the polyol composition (ii) comprises less than 10% by weight of polyols which exhibit a propylene oxide and/or butylene oxide group.

53. The process for the production of a fiber composite material according to any of embodiments 31 to 52, wherein the polyol composition (ii) comprises no polyols which exhibit a propylene oxide or butylene oxide group.

54. The process for the production of a fiber composite material according to any of embodiments 31 to 53, wherein the polyol composition (ii) comprises at least one reactive diluent, the at least one reactive diluent preferably comprising a substance with at least one olefinic group, preferably a substance with at least two olefinic groups, more preferably a substance with at least one terminal olefinic group, more preferably at least two terminal olefinic groups.

55. The process for the production of a fiber composite material according to any of embodiments 31 to 54, wherein the polyurethane comprises an epoxy resin.

56. The process for the production of a fiber composite material according to embodiment 55, wherein the polyurethane comprises the epoxy resin in 1% to 50% by weight, preferably in 5% to 25% by weight, based each time on the total weight of the polyol composition (ii).

57. The process for the production of a fiber composite material according to any of embodiments 31 to 56, wherein the isocyanate composition (i) and/or the polyol composition (ii), preferably the isocyanate composition (i) and the polyol composition (ii), each exhibit a viscosity at 25° C. of less than 1000 mPa·s, preferably of <500 mPa·s (ASTM D445 (25° C.)).

58. The process for the production of a fiber composite material according to any of embodiments 31 to 57, wherein polyisocyanate composition (i) and polyol composition (ii), preferably polyisocyanate composition (i) and all groups which react with isocyanate, are used in such a ratio that the isocyanate index is between 99 and 400, preferably between 100 and 250.

59. The process for the production of a fiber composite material according to any of embodiments 31 to 58, wherein, apart from (i), (ii) and the fibers (b), no further components are added after the mixing of (i) and (II) or after the addition of (b).

60. The process for the production of a fiber composite material according to any of embodiments 31 to 59, wherein neither (i) nor (ii) comprises urethane, urea, amide, biuret, allophanate or isocyanurate groups.

61. The process for the production of a fiber composite material according to any of embodiments 31 to 60, wherein (i) comprises an isocyanate prepolymer.

62. The process for the production of a fiber composite material according to any of embodiments 31 to 61, wherein further auxiliaries and/or additives are added, the further auxiliaries and/or additives preferably being comprised in the polyol composition (ii), more preferably the at least trifunctional alcohol (ii.1), which exhibits at least two primary hydroxyl groups, preferably three primary hydroxyl groups, more preferably the ethoxylated polyether polyol (ii.1) which comprises further auxiliaries and/or additives, more preferably the ethoxylated polyether polyol (ii.1) is obtained or obtainable by reaction of a polyol initiator (ii.1.1) with a functionality of 3 to 6, preferably 3 or 4, with ethylene oxide (ii.1.2), in the presence of an alkoxylation catalyst (ii.1.3) and the further auxiliaries and/or additives (ii.1.4).

63. The process for the production of a fiber composite material according to any of embodiments 31 to 62, wherein further auxiliaries and/or additives are added, the further auxiliaries and/or additives preferably being comprised in the isocyanate composition (i).

64. The process for the production of a fiber composite material according to any of embodiments 31 to 63 using the fiber winding process, by mixing the polyisocyanate composition (i) and the polyol composition (ii), metering them into an impregnation bath and bringing them into contact there with the fibers (b), the impregnated fibers subsequently being placed on a winding spindle, a tool or a component.

65. The process for the production of a fiber composite material according to any of embodiments 31 to 63 using the long fiber injection process, by mixing the polyisocyanate composition (i) and the polyol composition (ii), trickling cut fibers (b) into the reaction mixture, preferably at the mixing head, then spraying the material into a mold and/or onto a support and subsequently curing there.

66. The process for the production of a fiber composite material according to any of embodiments 31 to 63 using the fiber spraying process, by mixing the polyisocyanate composition (i) and the polyol composition (ii), bringing the reaction mixture into contact with fibers and subsequently curing it.

67. The process for the production of a fiber composite material according to any of embodiments 31 to 63 using the pultrusion process, by mixing the polyisocyanate composition (i) and the polyol composition (ii), metering the reaction mixture into a closed impregnation device, in which it comes into contact with continuous oriented fibers and/or fiber mats (b), which are continuously drawn through a mold and then cured.

68. The process for the production of a fiber composite material according to any of embodiments 31 to 63 using the RTM process, by mixing the polyisocyanate composition (i) and the polyol composition (ii), metering them into an at least partially evacuated mold, in which a preform made of fibers (b) was inserted beforehand, and subsequently curing in the mold.

69. The process for the production of a fiber composite material according to any of embodiments 31 to 63 for the production of an SMC (sheet molding compound), by mixing the polyisocyanate composition (i) and the polyol composition (ii), applying them to at least one of two carrier films, bringing them into contact with reinforcing fibers, bringing the two carrier films together to form a sandwich and rolling them, the SMC optionally being stored cut in stacks or rolled up, one or more of the SMC parts optionally after removal of the carrier film being consolidated and cured in a pressing tool to form the component.

70. The process for the production of a fiber composite material according to any of embodiments 31 to 63 for the production of fibers or textiles preimpregnated with polyurethane (polyurethane prepregs), by mixing the polyisocyanate composition (i) and the polyol composition (ii), bringing them into contact with the oriented fibers (b) and subsequently partially curing them.

71. The process for the production of a fiber composite material according to any of embodiments 31 to 63 for the production of fibers or textiles preimpregnated with polyurethane (polyurethane prepregs), by mixing the polyisocyanate composition (i) and the polyol composition (ii), polymerizing them at a temperature below 80° C. and subsequently bringing them into contact with the oriented fibers (b).

72. A fiber composite material obtained or obtainable by the process according to any of embodiments 31 to 71.

73. The use of a fiber composite material according to any of embodiments 1 to 30 or of a fiber composite material obtained or obtainable by the process according to any of embodiments 31 to 71 for the production of a pipe, in particular a conical pipe, a pipe connector, a pressure vessel, a storage tank, an insulator, a mast, a bar, a roller, a torsion shaft, a profile, a piece of sports equipment, a molded part, a cover, an automotive exterior part, a rope, a cable, an isogrid structure or a semi-finished textile product.

The following examples serve to illustrate the invention but are in no way limiting with regard to the subject matter of the present invention.

### EXAMPLES

1. Chemicals

| Abbreviation | Chemical description |
|---|---|
| Polyol 1 | Propoxylated glycerol (glycerol-PO) OHN 805 mg KOH/g, viscosity |
| | 1275 mPa · s [25° C], |
| Polyol 2 | Castor oil |
| Polyol 3 | Branched polyether/polyester, not containing EO, OHN 170 mg |
| | KOH/g, viscosity 3500 mPa · s [25° C.] |
| Polyol 4 | Trimethylolpropane (TMP)-initiated ethoxylated polyol with an OH |
| | number (OHN) of 935 mg KOH/g, prepared with KOH as catalyst for |
| | the ethoxylation |
| Polyol 5 | Propoxylated propylene glycol, OHN 248 mg KOH/g, viscosity 75 |
| | mPa · s [25° C.] |
| Polyol 6 | Trimethylolpropane, OHN 1250 |
| Polyol 7 | Branched polyether/polyester, not containing EO, OHN 315, viscosity |
| | 1000 mPa · s [25° C.] |
| Catalyst 1 | 40% by weight solution of potassium acetate in dipropylene glycol |
| | (DPG) |
| Catalyst 2 | Phenol-blocked DBU |
| Catalyst 3 | LiCl-based composition, KX 146, BASF SE |
| Defoamer 1 | Xiameter ACP 1000 Antifoam Compound |
| Zeolite 1 | Zeolite dispersed in castor oil |
| Isocyanate 1 | Composition comprising 50% by weight of carbodiimide-modified |
| | diphenylmethane-4,4-diisocyanate (mean functionality 2.2, |
| | NCO content 29.5 g/100 g) and 50% by weight of isocyanate |
| | prepolymer based on diphenylmethane-4,4-diisocyanate, a polyether |
| | polyol (22.4-23.4 g/100 g) and dipropylene glycol |
| Isocyanate 2 | Composition comprising 99.9% by weight of isocyanate prepolymer |
| | based on diphenylmethane-4,4-diisocyanate, a polyether polyol |
| | (22.4-23.4 g/100 g) and dipropylene glycol and 0.1% by weight of |
| | dibis |
| Isocyanate 3 | Composition comprising 97.9% by weight of isocyanate prepolymer |
| | based on diphenylmethane-4,4-diisocyanate, a polyether polyol |
| | (22.4-23.4 g/100 g) and dipropylene glycol, 2% by weight of catalyst |
| | 3 and 0.1% by weight of dibis |
| Isocyanate 4 | Composition comprising 49.95% by weight of polymeric |
| | diphenylmethane-4,4-diisocyanate, 24.95% by weight of |
| | diphenylmethane-2,4-diisocyanate, 25% by weight of |
| | diphenylmethane-4,4-diisocyanate and 0.1% by weight of dibis |
| TMPTA | 1,1,1-Trihydroxymethylpropyl triacrylate |
| Dibis | Oxydiethylene bis(chloroformate) |
| Epoxy resin 1 | Epoxy resin based on bisphenol A and epichlorohydrin, epoxy |
| | equivalent weight 190 g/eq, determined according to ASTM D-1652. |
| | Viscosity at 25° C.: 12-14 Pa · s, determined according to ASTM D445 |

2. Test Methods

Shore D hardness test in accordance with DIN ISO 7619-1

3-point bending test in accordance with DIN EN ISO 178

Tensile strength in accordance with DIN EN ISO 527

Elongation at break in accordance with DIN EN ISO 527

Charpy impact strength (flatwise) in accordance with DIN EN ISO 179-1/1fU

Heat deflection temperature: HDT-B-f, flatwise at 0.45 MPa in accordance with DIN EN ISO 75

Hydroxyl number (OH number, OH N): DIN 53240

Content of epoxy groups: SMS 2026

Viscosity: ASTM D445 (25° C.)

Shrinkage: Polyol and isocyanate are mixed at ambient temperature and the reaction mixture is poured into a metallic mold with dimensions of 1000 mm×20 mm×10 mm. Excess material is removed with a doctor blade. The reaction mixture is cured at 80° C. for 1 hour and at 120° C. for 2 hours. After cooling to ambient temperature, the part is removed from the mold. The length of the test bar is compared with the length of the mold.

3. Production of Polyurethane Test Panels for Determination of the Mechanical Properties (Examples 1 to 5 and Comparative Examples 1 to 3)

Composition of the polyurethanes of examples 1 to 5 and comparative examples 1 to 3 as indicated in table 1. All starting materials apart from the isocyanate (usual batch size: 300 g of polyol composition) were mixed at ambient temperature under vacuum, then the isocyanate was added, followed by mixing for 60 s in the Speedmixer (FA Hauschild); subsequently the reaction mixture was poured into a metal mold of 20×30×0.4 cm or 20×30×0.2 cm, followed by scraping off the excess resin with a doctor blade and curing at 80° C. for 1 h, then at 120° C. for 2 h and at 180° C. for 2 h. Test specimens were subsequently milled from the material after storage for 1 week at ambient temperature.

4. Production of a Fiber Composite Material from Polyurethane and Glass Fibers by Means of a Fiber Winding Process (Filament Winding Process) to Determine the Tendency to Form Bubbles at 80% Atmospheric Humidity (Examples 1 to 5 and Comparative Examples 1 to 3)

Composition of the polyurethanes of examples 1 to 5 and comparative examples 1 to 3 as indicated in table 1. A conventional fiber winding system (filament winding system), located within an enclosure with an extraction system, was used. The desired atmospheric humidity could be set within the enclosure via an air humidifier. A bobbin with continuous glass fibers, which was mounted inside the enclosure, was used. The glass fibers were guided through the as yet unfilled impregnation bath and then laid down on a mandrel via the laying head. The mandrel was clamped at both ends into the rotation device. The impregnation bath and the laying head were located on a carriage, by means of which fibers can be laid down over the length of the mandrel. The movement of the carriage, the rotation of the mandrel and the intended laying angle of the fibers on the mandrel as a function of time were programmed and then controlled by the winding software. The glass fibers used were SE3030 glass fibers from 3B (boron-free glass fibers, 17 μm filament diameter, tex 2400 (g/km)). The winding pattern chosen was: 2 circumferential plies, one ply +/−45° and two circumferential plies. The tests were carried out at a temperature of 25° C. and an atmospheric humidity of 85%. The resin impregnation bath was heated to 20° C. At the beginning of the test, all starting materials apart from the isocyanate (usual batch size: 100 g of polyol composition) were mixed at ambient temperature, after which the isocyanate was added and mixing was carried out for 60 s in a Speedmixer (FA Hauschild). The material was subsequently charged to the impregnation bath. Then the rove (the roving) was drawn manually so far until the resin-impregnated roving could be laid down on the mandrel and fixed there. Then the winding program was started and several plies of polyurethane-impregnated glass fibers were laid down on the mandrel. On conclusion of the winding process, the glass fiber was severed and the material was left to cure in the enclosure at ambient temperature for 1 hour. Curing was subsequently carried out at 80° C. for 1 hour and at 120° C. for 2 hours.

The quality of the component surface was visually assessed:

1: smooth surface without microbubbles

2: relatively smooth surface with a few microbubbles

3: large number of microbubbles

4: rough, foam-like component surface

5: many air bubbles with a diameter >1 mm, white, foam-like component surface

TABLE 1
Composition of the polyurethanes of examples 1 to 5 and of comparative examples 1 to 3, and the properties thereof

| | Comparative | Example | Comparative | Example | Example | Example | Example | Comparative |
|---|---|---|---|---|---|---|---|---|
| | example 1 | 1 | example 2 | 2 | 3 | 4 | 5 | example 3 |
| Polyol 1 [% by weight] | 96.8 | 0 | 15 | 0 | 0 | 0 | 0 | 0 |
| Polyol 2 [% by weight] | 0 | 0 | 36.7 | 20 | 0 | 0 | 0 | 55.9 |
| Polyol 3 [% by weight] | 0 | 69.8 | 0 | 0 | 0 | 0 | 0 | |
| Polyol 4 [% by weight] | 0 | 20 | 0 | 29.8 | 33.9 | 0 | 17.9 | 14 |
| Polyol 5 [% by weight] | 0 | 0 | 15 | 0 | 0 | 0 | 0 | 0 |
| Polyol 6 [% by weight] | 0 | 0 | 0 | 0 | 0 | 30.6 | 0 | 0 |
| Polyol 7 [% by weight] | 0 | 0 | 0 | 0 | 0 | 0 | 40 | 0 |
| TMPTA [% by weight] | 0 | 0 | 30 | 40 | 40 | 66.2 | 32 | 10 |
| Epoxy resin 1 | 0 | 0 | 0 | 0 | 16 | 0 | 0 | 10 |
| Catalyst 1 [% by weight] | 0 | 0 | 0.1 | 0 | 0 | | 0 | 0 |
| Catalyst 2 [% by weight] | 0 | 0 | 0 | 0.1 | 0 | 0 | 0 | 0 |
| Defoamer 1 [% by weight] | 0.2 | 0.2 | 0.2 | 0.1 | 0.1 | 0.2 | 0.1 | 0.1 |
| Zeolite 1 [% by weight] | 3 | 10 | 3 | 10 | 10 | 3 | 10 | 10 |
| Isocyanate 1 [% by weight] | 268 | 0 | 137 | 0 | 0 | 111 | 110.6 | 0 |
| Isocyanate 2 [% by weight] | 0 | 0 | 0 | 127 | 0 | 0 | 0 | 0 |
| Isocyanate 3 [% by weight] | 0 | 0 | 0 | 0 | 176.0 | 0 | 0 | 98 |
| Isocyanate 4 [% by weight] | 0 | 80 | 0 | 0 | 0 | 0 | 0 | 0 |
| Isocyanate Index* | 120 | 110 | 120 | 120 | 160 | 102 | 140 | 180 |
| Shore D | 85 | 81 | 82 | 83 | 87 | 87 | 87 | 82 |
| Flexural strength [MPa] | 78 | 101 | 114 | 129 | 139 | 67 | 127 | 97 |
| Tensile strength [MPa] | 35 | 60 | 64 | 84 | 63 | 24 | 77 | 56 |
| Elongation at break [%] | 2 | 11 | 6 | 8 | 3 | 1 | 6 | 9 |
| Tensile modulus of elasticity [MPa] | 3211 | 2350 | 2960 | 3660 | 3000 | 3100 | 2745 | 2036 |
| Charpy impact strength | 9.3 | 62.5 | 21 | 44 | 39 | 7 | 30 | 33 |
| Heat deflection temperature HDT-B-f | 108 | 70 | 115 | 118 | 136 | 155 | 126 | 86 |
| Shrinkage [%] | 0.9 | 0.9 | 0.8 | 0.9 | 0.9% | 1.0 | 0.8 | 0.9 |
| Tendency to form bubbles - | Strong | Almost | Strong | Almost | Almost | Almost | None | Almost |
| winding test (25° C., 85% | (4) | none | (4) | none | none | none | (1) | none |
| atmospheric humidity) | | (1-2) | | (1-2) | (1-2) | (1-2) | | (1-2) |

*Isocyanate index numerically determined from the % by weight or amounts of the components used, taking their functionalities into account

It could be shown that the use of at least 15% by weight of at least trifunctional alcohols, which exhibit at least two primary hydroxyl groups, preferably three primary hydroxyl groups, in particular of ethoxylated polyols, i.e. polyols which exhibit reactive primary hydroxyl groups, in the winding test led to significantly better results with regard to avoiding unwanted formation of bubbles: the polyurethanes based on at least 15% by weight of at least trifunctional alcohols, which exhibit at least two primary hydroxyl groups, preferably three primary hydroxyl groups, or at least 15% by weight of ethoxylated polyols, showed, in the winding test, despite high atmospheric humidity of 85%, no or at most very little formation of bubbles, whereas the use of propoxylated polyols or less than 15% by weight of the abovementioned polyols led to foaming, i.e. undesirable bubbles formed. The examples and comparative examples show that, in addition to the better processability in the winding process, there are advantages with regard to all of the mechanical properties considered, in particular with the impact strength.

Surprisingly, it could also be shown that a high isocyanate index can be used. A person skilled in the art would conventionally select the index such that there is no or only a minimal excess of isocyanate in an open winding process (isocyanate index 100-120). It is generally believed that a high isocyanate index increases the risk of undesirable reactions of the isocyanate with atmospheric moisture taking place during production. It has surprisingly been found that the polyol composition according to the invention makes it possible to use a high excess of isocyanate (index 99-400, preferably 100-250).

The examples and comparative examples show that, when the polyol composition according to the invention is used, surprisingly improved properties are also obtained with regard to a higher index—in particular with regard to heat deflection temperature—and surprisingly the processability/tendency to form bubbles is excellent despite the high index.

### CITED LITERATURE

WO 03/085022 A1

WO 2016/183073 A1

M. Ionescu, Chemistry and Technology of Polyols, Rapra, 2005, pp 67-75 WO 18/036943 A WO 19/025439 A1

“Kunststoffhandbuch, Band 7, Polyurethane” [Plastics Handbook, Volume 7, Polyurethanes], Carl Hanser Verlag, 3rd Edition, 1993, Chapters 3.4.4 and 3.4.6 to 3.4.11 DE 102008021980 A1

WO 2009/115540 A1

Thomas Brock, Michael Groteklaes and Peter Mischke: Lehrbuch der Lacktechnologie

[Textbook of Paint Technology], Ed.: Ulrich Zorll, 2nd Edition, Vincentz Verlag, Hanover, 2000, ISBN 978-3-87870-569-7, Chap. 2.4.2.1, Defoamers and Deaerators, pp 169 et seq. “Handbook of Epoxy Resins” by Henry Lee and Kris Neville, McGraw-Hill Book Company, 1967

WO 2014/170252 A1

WO 2018/219756 A1

1. A fiber composite material comprising the following components:
a) a polyurethane obtained by reaction of at least the components:
i) a polyisocyanate composition; and
ii) a polyol composition comprising at least 15% by weight of an at least trifunctional alcohol (ii.1), which exhibits at least two primary hydroxyl groups, and less than 10% by weight of polyols which exhibit an end group based on propylene oxide and/or butylene oxide; and
b) fibers which are at least partially embedded in the compact polyurethane;
wherein polyisocyanate composition (i) and polyol composition (ii) are used in such a ratio that the isocyanate index is between 99 and 400.

2. The fiber composite material according to claim 1, comprising the following components:
a) a polyurethane obtained by reaction of at least the components:
i) a polyisocyanate composition; and
ii) a polyol composition comprising at least 15% by weight of an ethoxylated polyetherol (ii.1); and
b) fibers which are at least partially embedded in the compact polyurethane.

3. The fiber composite material according to claim 2, wherein the ethoxylated polyether polyol (ii.1) is obtained by reaction of:
ii.1.1) a polyol initiator with a functionality of 3 to 6,
with
ii.1.2) ethylene oxide,
in the presence of an alkoxylation catalyst (ii.1.3); and
ii.1.4) optionally further auxiliaries and/or additives.

4. The fiber composite material according to claim 2, wherein the ethoxylated polyether polyol (ii.1) exhibits no end groups based on propylene oxide and/or end groups based on butylene oxide.

5. The fiber composite material according to claim 2, wherein the polyol initiator (ii.1.1) of the ethoxylated polyether polyol (ii.1) comprises a triol with a functionality of 3

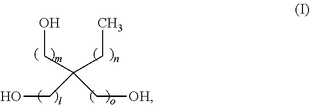

6. The fiber composite material according to claim 2, wherein the ethoxylated polyether polyol (ii.1) is produced only by the reaction of a polyol initiator (ii.1.1.) and ethylene oxide (ii.1.2), and no further alkylene oxide is used, and/or wherein the ethoxylated polyether polyol (ii.1) is produced only by the reaction of a polyol initiator (ii.1.1.) and ethylene oxide (ii.1.2), and no further initiator, is used.

7. The fiber composite material according to claim 2, wherein the ethoxylated polyether polyol (ii.1) is based on a triol exhibiting the formula (II): 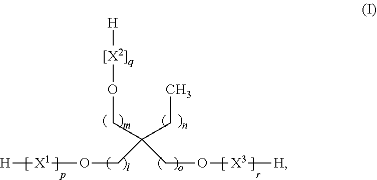
wherein
l, m, n and o are each independently of one another an integer from the range from 1 to 6;
p, q and r are each independently of one another zero or an integer from the range from 1 to 6;
and X¹, X² and X³ are each a —CH₂—CH₂—O— group.

8. The fiber composite material according to claim 1, wherein the polyol composition (ii) comprises no polyols which exhibit a propylene oxide end group or butylene oxide end group, and/or wherein the polyol composition (ii) comprises less than 10% by weight of polyols which exhibit a propylene oxide and/or butylene oxide group.

9. The fiber composite material according to claim 1, wherein the polyol composition (ii) comprises no polyols which exhibit a propylene oxide or butylene oxide group and/or wherein the polyol composition (ii) comprises no polyols based on propylene oxide and/or butylene oxide.

10. A process for the production of a fiber composite material according to claim 1, comprising the stages:
A) providing a polyisocyanate composition (i);
B) providing a polyol composition (ii) comprising at least 15% by weight of an at least trifunctional alcohol (ii.1), which exhibits at least two primary hydroxyl groups, and less than 10% by weight of polyols which exhibit an end group based on propylene oxide and/or butylene oxide;
C) mixing polyisocyanate composition (i) and polyol composition (ii) to obtain a polyurethane reaction mixture (a′); and
D) reacting the polyurethane reaction mixture (a′) in the presence of fibers (b) to yield a polyurethane (a), the fibers (b) being at least partially embedded in the polyurethane reaction mixture (a′) or in the polyurethane (a), to obtain a fiber composite material;
wherein polyisocyanate composition (i) and polyol composition (ii) are used in such a ratio that the isocyanate index is between 99 and 400.

11. The process for the production of a fiber composite material according to claim 10, comprising the stages:
A) providing a polyisocyanate composition (i);
B) providing a polyol composition (ii) comprising at least 15% by weight of an ethoxylated polyether polyol (ii.1) and less than 10% by weight of polyols which exhibit an end group based on propylene oxide and/or butylene oxide;
C) mixing polyisocyanate composition (i) and polyol composition (ii) to obtain a polyurethane reaction mixture (a′); and
D) reacting the polyurethane reaction mixture (a′) in the presence of fibers (b) to yield a polyurethane (a), the fibers (b) being at least partially embedded in the polyurethane reaction mixture (a′) or in the polyurethane (a), to obtain the fiber composite material.

12. The process for the production of a fiber composite material according to claim 10 for the production of fibers or textiles preimpregnated with polyurethane (polyurethane prepregs), comprising mixing the polyisocyanate composition (i) and the polyol composition (ii), bringing them into contact with oriented fibers (b), and subsequently partially curing them.

13. The process for the production of a fiber composite material according to claim 10 for the production of fibers or textiles preimpregnated with polyurethane, comprising mixing the polyisocyanate composition (i) and the polyol composition (ii), polymerizing them at a temperature below 80° C., and subsequently bringing them into contact with oriented fibers (b).

14. A fiber composite material obtained by the process according to claim 10.

15. A method of using the fiber composite material according to claim 1, the method comprising using the fiber composite material for the production of a pipe, a conical pipe, a pipe connector, a pressure vessel, a storage tank, an insulator, a mast, a bar, a roller, a torsion shaft, a profile, a piece of sports equipment, a molded part, a cover, an automotive exterior part, a rope, a cable, an isogrid structure or a semi-finished textile product.

16. The fiber composite material according to claim 2, wherein the ethoxylated polyether polyol (ii.1) is obtained by reaction of:
ii.1.1) a polyol initiator with a functionality of 3 or 4,
with
ii.1.2) ethylene oxide,
in the presence of an alkoxylation catalyst (ii.1.3); and
ii.1.4) optionally further auxiliaries and/or additives.

17. The fiber composite material according to claim 2, wherein the ethoxylated polyether polyol (ii.1) exhibits exclusively end groups based on ethylene oxide.

18. The fiber composite material according to claim 2, wherein the ethoxylated polyether polyol (ii.1) exhibits exclusively groups based on ethylene oxide and comprises no groups based on propylene oxide and/or groups based on butylene oxide.

19. The fiber composite material according to claim 2, wherein the polyol initiator (ii.1.1) of the ethoxylated polyether polyol (ii.1) comprises a triol of the formula (I): 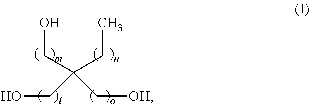
wherein l, m, n, and o are each independently an integer from the range from 1 to 6.

20. The fiber composite material according to claim 7, wherein l, m, n, and o are all 1.
